(19) United States
(12) Patent Application Publication
(10) Pub. No.: US 2014/0271077 A1
(43) Pub. Date: Sep. 18, 2014

(54) COMPOSITE MATERIAL STRUCTURES CONFIGURED FOR ALTERNATING COMPRESSIVE AND TENSILE LOADING

(71) Applicant: CATERPILLAR INC., Peoria, IL (US)

(72) Inventor: Aaron K. Amstutz, Peoria, IL (US)

(73) Assignee: Caterpillar Inc., Peoria, IL (US)

(21) Appl. No.: 13/828,094

(22) Filed: Mar. 14, 2013

(51) Int. Cl. E02F 3/38; B32B 5/12; B29C 65/72

(52) U.S. Cl. CPC E02F 3/38; B29C 65/72; B32B 5/12
USPC 414/722; 264/152; 428/113

(57) ABSTRACT

A composite material structure and a method for making the composite material structure are provided. The composite material structure includes a first stack of fiber panels arranged with fibers parallel to a loading axis to accommodate a first tension load in a first plane. The composite material structure includes a second stack of fiber panels arranged with fibers parallel to the loading axis to accommodate a second tension load in a second plane. The composite material structure includes a pre-consolidated fabric structure between the first and the second stack arranged with fibers plied perpendicular to the fibers of the first stack of fiber panels and perpendicular to the fibers of the second stack of fiber panels, the fibers further being orthogonal to the loading axis.

### TECHNICAL FIELD

The disclosure relates to composite material structures and manufacturing processes thereof. More particularly, the disclosure relates to composite material structures for alternating compressive and tensile loading and manufacturing processes thereof.

### BACKGROUND

Both automotive and aerospace industries have been increasingly utilizing carbon-fiber composites that have a higher strength-to-weight ratio compared to other materials (e.g., metals/alloys). Unfortunately, in many applications, such as construction equipment, using carbon-fiber composites poses significant challenges in compressive loading and even more challenges when compressively loaded after an impact event. In this regard, minor impacts can substantially reduce the ability to handle loads, especially compressive loads. Glass-fiber composites have somewhat better compressive loading performance and impact resistance than carbon-fiber composites but are not as light. Polymer-fiber composites have better impact resistance but only moderate compressive loading capabilities. Nevertheless, many composite materials still suffer from poor performance after impact due to the use of light-weight core materials with limited resiliency.

Current construction equipment parts, such as excavator sticks, excavator booms, truck body frame members, and other components, use metallic components such as steel-plate in a box cross-section that makes such parts heavy. Such components have high strength and high impact resistance; however, they are also very heavy. Composites have typically not been a suitable material due to the previously mentioned issues with impact resistance and/or loss of strength after impact which is a critical factor in construction equipment.

Conventional construction for composite materials requiring high compressive strength may deploy a weaving procedure to create a three-dimensional fabric, such as that described in U.S. Pat. No. 5,173,358. Such an approach may improve the strength of a structure in multiaxial loading; however, such a procedure is complex and adds considerably to the cost of a large structure. Moreover, such approaches may utilize more fiber content than required in non-necessary directions due to requirements of the weaving process.

### SUMMARY

According to an aspect of this disclosure, a composite material structure is provided. The composite material structure includes a first stack of fiber panels arranged with fibers parallel to a loading axis to accommodate a first tension load in a first plane. The composite material structure includes a second stack of fiber panels arranged with fibers parallel to the loading axis to accommodate a second tension load in a second plane. The composite material structure includes a pre-consolidated fabric structure between the first and the second stack arranged with fibers plied perpendicular to the fibers of the first stack of fiber panels and perpendicular to the fibers of the second stack of fiber panels, the fibers further being orthogonal to the loading axis.

According to an aspect of this disclosure, a method of manufacturing a composite material structure for alternating flexural loading comprising compressive and tensile stresses is provided. The method includes dividing a first panel of a composite material into a plurality of strips along a first direction. The method includes combining the plurality of strips to form a second panel. The method includes attaching a plurality of fiber panels on the top and bottom of the second panel to form a composite plate. The method includes dividing the second stack composite plate of the composite material into a plurality of strips along a second direction, the plurality of strips along the first and the second directions forming a composite material structure. According to an aspect of this disclosure, an excavator stick is provided. The excavator stick includes a pre-consolidated fabric structure made of a composite material between a first and a second stack of fiber panels arranged with fibers plied perpendicular to fibers of the first stack of fiber panels and perpendicular to the fibers of the second stack of fiber panels, the fibers further being orthogonal to a loading axis along which the excavator stick receives flexural forces.

### BRIEF DESCRIPTION OF THE DRAWINGS

FIG. 1 shows a partially exploded composite material structure, in accordance with an aspect of the disclosure.

FIG. 2 shows a material arrangement during a construction process of the composite material structure of FIG. 1, in accordance with an aspect of the disclosure.

FIG. 3 shows a flowchart of a process manufacturing the composite material structure for alternating compressive and tensile loading, in accordance with an aspect of the disclosure.

### DETAILED DESCRIPTION

In one aspect of this disclosure, a composite material construction that exhibits high retention of compressive properties after impact is provided.

In another aspect of this disclosure, a composite material construction that can be assembled using low cost two-dimensional weaving and laminating processes to construct a structure that exhibits high retention of compressive properties after impact is provided.

In another aspect of this disclosure, a composite material construction that substantially limits the compressive loading carried by the structural skins by providing a core construction that exhibits high modulus in both the traditional through-thickness direction as well as in the in-plane direction is provided.

In another aspect of this disclosure, a composite material construction that has a core section construction that may carry torsional loading that may be applied to a beam member is provided.

In another aspect of this disclosure, a composite material construction that has edge skins that may carry shear loading to limit such loading to the core section construction so as to avoid the necessity and cost of three-dimensionally woven structures is provided.

Various aspects of this disclosure are realized by creating a pre-consolidated core section construction of substantially two-dimensional laminated composite material that is arranged perpendicular to the skins. Such core section may be built-up using 0°/90° biaxial fabric or two-dimensionally woven fabric which is subsequently oriented perpendicularly to the skins. The core section may be additionally laminated with fabric at angles other than 0°/90° (e.g., +/−45°) to impart torsional stiffness to a beam. This core section construction possesses a high compressive modulus in-plane, which is parallel to the skin direction, and thus limits the compressive loading transferred to the skins.

Furthermore, in one aspect of the disclosure, the beam may be constructed with biased fabric (e.g., +/−45°) on either side of the structure, along the main span, to impart high shear modulus to the structure.

Further details of the construction are delineated in the remainder of this disclosure.

FIG. 1 shows a partially exploded composite material structure 100. The composite material structure 100 includes a first stack of fiber panels 102 (top skin), a second stack of fiber panels 108 (bottom skin), a third stack of fiber panels 120, a fourth stack of fiber panels 122, and a pre-consolidated fabric structure 118. The pre-consolidated fabric structure 118 may be surrounded by and/or attachable to the first stack of fiber panels 102, the second stack of fiber panels 108, the third stack of fiber panels 120, and the fourth stack of fiber panels 122. Although not explicitly shown in FIG. 1, the pre-consolidated fabric structure 118 may be surrounded by additional stacks of fiber panels on its sides, e.g., the sides not visible in FIG. 1.

It is to be noted that the third stack of fiber panels 120 and the fourth stack of fiber panels 122 are shown separated (exploded) from the pre-consolidated fabric structure 118 for discussion purposes only. In use, the composite material structure 100 is formed with the third stack of fiber panels 120 arranged on the right end of the composite material structure 100, along the YZ-plane, covering the pre-consolidated fabric structure 118 and the edges of the first stack of fiber panels 102 and the second stack of fiber panels 108 as shown by arrows 130. The fourth stack of fiber panels 122, as well as other stacks of fiber panels (not shown) may be attached to the pre-consolidated fabric structure 118 along the front side thereof (along the XZ-plane) covering the pre-consolidated fabric structure 118 and the edges of the first stack of fiber panels 102 and the edges of the second stack of fiber panels 108 as shown by an arrow 132.

The term “composite” when applied to materials may relate to materials made from two or more constituent materials. The term may also apply when the same material is used as fiber and matrix but where each constituent retains discrete mechanical characteristics. Such constituent materials may have different physical or chemical properties, and when combined, may produce a material with characteristics different from the individual components. The individual components may remain separate and distinct within the finished structure. By way of example only and not by way of limitation, typical composite materials may include a self-reinforced polymer (SRP) material, high modulus fiber material comingled with a polymer fiber material and thermally consolidated, high modulus fiber material infused with a thermosetting resin matrix, high modulus fiber material infused with a reactive thermoplastic material (e.g., Cyclic polybutylene terephthalate (PBT)), and combinations thereof, or the like. In one aspect, the composite material structure 100 may be part of an excavator stick, an excavator boom, a truck body frame member, material handler linkages, telehandler linkages, or other hardware components that may be used as impact-resistant lightweight structures. For example, an excavator stick may be made or assembled using the composite material structure 100.

In one aspect, one or more dimensions of the composite material structure 100 may be varied. For example, the composite material structure 100 may have different thicknesses along different axes. For example, in the Cartesian coordinate system indicated by the “XYZ” axes arrows shown in FIG. 1, the composite material structure 100 may be at least 1″, at least 2″, at least 3″, at least 4″, or higher along one or more of such axes. In one aspect, the composite material structure 100 may have shapes other than a three-dimensional cube structure, which is illustrated in FIG. 1 for discussion purposes by way of example only. Further, spatial relationships between various components of the composite material structure 100 may be different from those shown in FIG. 1. For example, the first stack of fiber panels 102, the second stack of fiber panels 108, the third stack of fiber panels 120, the fourth stack of fiber panels 122, and the pre-consolidated fabric structure 118, or internal components thereof may be arranged in an orientation different from that shown in FIG. 1.

The first stack of fiber panels 102 includes a plurality of layers 102(1)-102(n), where index ‘n’ is an integer. In one aspect, the index ‘n’ may be in a range equal to 8-200. Therefore, the first stack of fiber panels 102 may include 8-200 layers of composite fiber material, although such a range of the index ‘n’ is by way of example only and not by way of limitation. Each layer 102(1)-102(n) may be made of individual fibers 104. The fibers 104 may be arranged along the X-axis, or parallel to the X-axis as shown in FIG. 1. Alternatively, the fibers 104 may be at an angle with respect to the X-axis or the Y-axis, but may lie in the XY-plane. In one aspect, individual ones of the fibers 104 may have unique orientations relative to each other. For example, some fibers in the fibers 104 may be at a first angle and some may be at a second angle, different from the first angle, with respect to the X or the Y axis. In one aspect, the fibers 104 in one layer, e.g., the layer 102(1), may be oriented or arranged different from the fibers 104 in another layer, e.g., the layer 102(2). One of ordinary skill in the art, in view of this disclosure, will appreciate that numerous combinations of orientations of the fibers 104 may exist.

In one aspect, the XY-plane in which the first stack of fiber panels 102 lies is referred to herein as a first plane. The first stack of fiber panels 102 may be arranged to receive an external loading force in a direction of a loading axis 112, as illustrated in FIG. 1. Such loading axis 112 may be, for example, parallel to the directions of the fibers 104 along the X-axis. In one aspect, the external loading force may be a tensile or tension force that may result from flexural loading.

The second stack of fiber panels 108 includes a plurality of layers 108(1)-108(m), where index ‘m’ is an integer. In one aspect, the index ‘m’ may be in a range equal to 8-200. Therefore, the second stack of fiber panels 108 may include 8-200 layers of composite fiber material, although such a range of the index ‘m’ is by way of example only and not by way of limitation. Each layer 108(1)-108(m) may be made of individual fibers 110, similar to the fibers 104 in the layers 102(1)-102(n) of the first stack of fiber panels 102. The fibers 110 may be arranged along the X-axis, or parallel to the X-axis as shown in FIG. 1. Alternatively, the fibers 110 may be at an angle with the X-axis or the Y-axis, but may lie in another XY-plane parallel to the first plane. In one aspect, individual one of the fibers 110 may have unique orientations relative to each other. For example, some fibers in the fibers 110 may be at a first angle and some may be at a second angle, different from the first angle, with respect to the X or the Y axis. In one aspect, the fibers 110 in one layer, e.g., the layer 108(1), may be oriented or arranged different from the fibers 110 in another layer, e.g., the layer 108(2). One of ordinary skill in the art, in view of this disclosure, will appreciate that numerous combinations of orientations of the fibers 110 may exist.

In one aspect, the XY-plane in which the second stack of fiber panels 108 lies is referred to herein as a second plane, substantially parallel to the first plane in which the first stack of fiber panels 102 lies. Similar to the first stack of the fiber panels 102, the second stack of fiber panels 108 is arranged to receive an external loading force in (or, opposite) a direction of loading axis 112 as illustrated by an arrow 114 in FIG. 1. Such loading along the arrow 114 may be, for example, parallel to the directions of the fibers 110 along the X-axis. In one aspect, the external loading force may be a tensile or tension force that may result from flexural loading.

In one aspect, the compression forces (which may result from flexural loading) are applied perpendicularly to the respective surface of one or more of the first stack of the fiber panels 102, the second stack of fiber panels 108, the third stack of fiber panels 120, the fourth stack of fiber panels 122, and other side panels (not shown) are distributed within the three-dimensional fiber structure or mesh of the pre-consolidated fabric structure 118. Such distribution is indicated by double-arrows 115 inside the three-dimensional mesh of the pre-consolidated fabric structure 118. For example, due to the composite materials used in manufacturing the aggregate composite construction of the pre-consolidated fabric structure 118, the first stack of the fiber panels 102, the second stack of fiber panels 108, the third stack of fiber panels 120, the fourth stack of fiber panels 122, and other side panels (not shown) are not bent/buckled/delaminated when such compression forces are applied to them since the pre-consolidated fabric structure 118 addresses such compression forces in the aggregate composite construction.

Likewise, the third stack of fiber panels 120 includes a plurality of layers 120(1)-120(k), where index ‘k’ is an integer, and the fourth stack of fiber panels 122 includes a plurality of layers 122(1)-122(j), where index T is an integer. Indices ‘n’, ‘m’, T, and ‘k’ may or may not be equal to each other. The third stack of fiber panels 120 and the fourth stack of fiber panels 122 are attached to sides of the pre-consolidated fabric structure 118, and are perpendicular to the first stack of fiber panels 102 and the second stack of fiber panels 108. In one aspect, the third stack of fiber panels 120 and the fourth stack of fiber panels 122 may include fibers in each respective layer arranged in the same manner as the fibers 104 and/or 110. In one aspect, the third stack of fiber panels 120 and/or the fourth stack of fiber panels 122 may include fibers arranged at angular orientations non-parallel to the respective edges of the third and fourth stacks of fiber panels 120 and 122. One such angular orientation is illustrated for the fourth stack of fiber panels 122 that includes the fibers 123 at an angle θ with respect to a perpendicular line 126 in the Z-direction. By way of example only and not by way of limitation, the angle θ may lie in a range of 25° to 65°. In one aspect, the angle θ may lie in a range of 25°-90°, although other variations of the angle θ may exist as may be contemplated by one of ordinary skill in the art after reading this disclosure.

The pre-consolidated fabric structure 118 includes fibers 118(1) plied in a direction 116 perpendicular or substantially perpendicular to the first and the second planes in which the first stack of fiber panels 102 and the second stack of fiber panels 108 lie, respectively, and hence, perpendicular to the loading axis 112. The pre-consolidated fabric structure 118 includes fibers 118(2) arranged or oriented in a direction parallel or substantially parallel to the first and the second planes. In one aspect, at least one of the fibers 118(1) and 118(2) may be arranged or oriented in non-perpendicular directions with respect to each other. For example, the fibers 118(1) and 118(2) may be at an angle α≠90° with respect to each other. The angle α may be in a range 25°-65°, although other values of the angle α may be contemplated by one of ordinary skill in the art in view of this disclosure. In one aspect the angle α may be substantially equal to 90°. As such, the pre-consolidated fabric structure 118 forms a plied two-dimensional mesh arranged so that compressive stresses due to flexural loading on a beam arrangement of the structures are borne by at least a portion of the plied pre-consolidated fabric structure 118. Arrangement of the fibers 118(1) and 118(2) enables the composite material structure 100 to absorb compression forces within the pre-consolidated fabric structure 118 orthogonal to the surfaces of the first and second stacks of fiber panels 102 and 108. The compression forces may be absorbed in region shown by the arrows 115 or dissipated inside the pre-consolidated fabric structure 118 as a bending load that causes the composite material structure 100 to bend in a direction indicated by an arrow 124 (or the opposite direction). Concurrently, tensile loads are borne in fiber panels 102 in the direction indicated by the arrow for the loading axis 112. Specific dimensions of the pre-consolidated fabric structure 118 depend on specific applications in which the composite material structure 100 may be used. For example, the pre-consolidated fabric structure 118 may have dimensions of approximately 16″×2″×2″ (length X breadth X height), although other dimensions may be used. An example construction of the pre-consolidated fabric structure 118 is discussed with respect to FIG. 2.

It is to be noted that although FIG. 1 discusses tension and/or compression forces being applied to the first stack of fiber panels 102 and orthogonal set of fiber panels in the pre-consolidated fabric structure 118, such forces may be applied to other parts of the composite material structure 100. For example, such forces may be applied to the third stack of fiber panels 120 and/or the fourth stack of fiber panels 122, along with forces applied at fiber panels oppositely facing the third stack of fiber panels 120 and/or the fourth stack of fiber panels 122 (not shown). In one aspect, the composite material structure 100 is a symmetrical structure and therefore, forces may be applied symmetrically to any pair of opposing stack of fiber panels; e.g., flexural loading may be applied that would develop tension in the first stack of fiber panels 102 and compressive loading in the region shown by arrows 115 in the pre-consolidated fabric structure 118, but equally valid would be the application of flexural loading opposite that indicated by arrow 124 such that tension is developed in the second stack of fiber panels 108 while compressive loading is borne in the top portion of the pre-consolidated fiber structure 118. For example, alternating symmetrical application of forces may include equal magnitudes of flexural forces being applied to the composite material structure 100. In another aspect, the composite material structure 100 may be an asymmetrical structure and therefore, forces may be applied asymmetrically to any pair of opposing stack of fiber panels (e.g., the first stack of fiber panels 102 and the second stack of fiber panels 108). For example, asymmetrical application of flexural forces may result in unequal magnitudes of tension and compression forces being applied to the composite material structure 100. Further, the composite material structure 100 may be symmetrical or asymmetrical with respect to its aggregate composite construction, e.g., when the first stack of fiber panels 102, the second stack of fiber panels 108, the third stack of fiber panels 120, and the fourth stack of fiber panels 122 having varying thicknesses, or when the pre-consolidated fabric structure 118 has unequal dimensions along X, Y, and Z axes.

It is to be noted that although only two stacks of fiber panels, the first stack of fiber panels 102 (top skin) and the second stack of fiber panels 108 (bottom skin), are illustrated as attached to the pre-consolidated fabric structure 118, the composite material structure 100 may include the third stack of fiber panels 120 and/or the fourth stack of fiber panels 122, along with opposing stacks of fiber panels (not shown) also attached to the pre-consolidated fabric structure 118. Further, the composite material structure 100 may be one of many such composite material structures used, for example, in making an excavator stick, or the like, for construction machinery that has an array of composite material structures forming a composite beam structure for the excavator stick.

FIG. 2 shows material arrangements 200 during the construction process of the pre-consolidated fabric structure 118 of the composite material structure 100, in accordance with an aspect of the disclosure. The term “pre-consolidated” may relate to the material arrangements 200 being available or being created prior to attaching the first, the second, the third, and the fourth stacks of the fiber panels 102, 108, 120, 122, respectively, or other stacks of fiber panels to resulting sides of the plied two-dimensional mesh of the pre-consolidated fabric structure 118. The material arrangements 200 includes a starting fiber panel 202 as the first fiber panel with which construction of the pre-consolidated fabric structure 118 begins (shown as the upper structure of FIG. 2). This is referenced as step 1 although there may be other steps prior to step 1. The fiber panel 202 may be itself made of composite material. Fiber panel 202 may ideally be between 0.25″ and 2.0″ thick. Furthermore, fiber panel 202 may be a laminated structure with 0°/90° biaxial fabric, woven fabric, triaxial fabric, quadraxial fabric, laminated with +/−45° layers interspersed, or the like. In one embodiment, multiple angles may be employed in the construction of fiber panel 202 to arrive at a two-dimensionally isotropic structure that will ultimately yield the composite material structure 100 with adequate torsional stiffness while maintaining the high in-plane compressive modulus in the direction of arrows 115 and perpendicular compressive modulus in the direction 116. The term “isotropic” may relate to composite material structure 100 having substantially similar properties along any two different (e.g., orthogonal) directions.

The dividing lines 206 are indicated along which the starting fiber panel 202 may be divided or cut resulting in a plurality of strips 204 (shown in the lower structure of FIG. 2). In one aspect, the dividing lines 206 may be oriented in a direction parallel to one of the edges of the starting fiber panel 202. However, in one aspect, the dividing lines 206 may be along other directions, non-parallel to the edges of the fiber panel 202. The dividing lines 206 may be separated from each other by a pre-determined distance. Such pre-determined distance determines (in-part) how tall the overall composite material structure 100 will be. Actual values of such pre-determined distance will depend on factors such as precision of cutting (e.g., using hand tools or lasers), compression or tension force magnitudes, section modulus required by the application of composite material structure 100, etc. Such granularity may be determined based upon the application in which the composite material structure 100 is to be used, and can be understood by one of ordinary skill in the art in view of this disclosure. The plurality of strips 204 may be arranged by rotating by 90° around an axis delineated by the dividing lines 206 drawn on starting fiber panel 202. Thereafter, the plurality of strips 204 may be closely arranged by pushing or applying a force along arrows 216, and consolidated or cured to form the precursor to the pre-consolidated fabric structure 118.

Subsequently, a fiber panel 210 may be attached to the top of the consolidated structure, the fiber panel 210 will ultimately become top skin fiber panel 102. Additionally, a fiber panel 212 may be attached to the bottom of said consolidated structure, the fiber panel 212 will ultimately become bottom skin fiber panel 108. Fiber panels 210 and 212 may be made of a composite material, similar to or different from the composite material of the fiber panel 202. The structure formed by attaching fiber panels 210 and 212 to the consolidated strips 204 may be subsequently be divided or cut along dividing lines 208. This is referenced as step 2 although there may be other steps between step 1 and step 2. The dividing lines 208 are along a direction different from the direction of the dividing lines 206. In one aspect, the dividing lines 208 may be perpendicular to the dividing lines 206. In another aspect, the dividing lines 208 may be at an angle other than 90° with respect to the dividing lines 206. In a further aspect, the dividing lines 208 may be along the X-axis for the resulting composite material structure 100. Similar to the dividing lines 206, the dividing lines 208 may be oriented at a pre-determined distance from each other based on the above-noted exemplary factors. After the structure is sectioned along dividing lines 208, a material arrangement shown as the composite material structure 100 is achieved.

### INDUSTRIAL APPLICABILITY

FIG. 3 presents a flowchart of a manufacturing process or a method 300 of manufacturing the composite material structure 100 for alternating compressive and tensile loading, in accordance with an aspect of the disclosure. The method 300 is described with reference back to FIGS. 1 and 2, using the material arrangements 200 as an example. Generally and conventionally, in the construction industry, machine parts such as excavator sticks are made with steel-plate in a box cross-section. The inventor has determined that making the entire envelope out of polymer-fiber composites (e.g., self-reinforced fiber polymer, or the like) may result in around 40% weight reduction. The fibers in the composite material structure 100 handle tensile loads or tension forces, and some shear forces, along the planar surfaces of the first stack of fiber panels 102, the second stack of fiber panels 108, the third stack of fiber panels 120, and the fourth stack of fiber panels 122, or other side panels (not shown). Thus, an engineering challenge is how to use lightweight materials for handling compressive loading or compression forces. Various aspects of the disclosure address the structural and fabrication needs of a majority of mass of the part in question (e.g., excavator stick). By having a dedicated compressive-load-carrying substructure (e.g., the pre-consolidated fabric structure 118), the entire weight of the part (e.g., excavator stick) may be reduced. By making a portion of a beam out of fabric (including fibers) plied perpendicularly to load path directions (e.g., the tensile loading axis 112), the compressive loads will be sustained in the pre-consolidated fabric structure 118 portion of the composite material structure 100 in the region indicated by arrows 115. Additionally, the densified composite material structure 100 has excellent impact resistance that would not be possible with a foam or honeycomb core structure. The other portions of the beam with fabric arranged in the traditional direction, e.g., the fibers 104 and 110 handle tension forces along the loading axis 112. Such construction geometry shown in FIGS. 1 and 2 may be embodied when utilized with polymeric-fiber composites (e.g., self-reinforced polymer) or composites with glass fiber co-mingled with polymer fibers that are heat consolidated, either of which have better impact resistance than carbon-fiber or glass-fiber composites that have traditional thermoset matrices.

One example method for generating perpendicular fabric layers, different than the method delineated in FIG. 2, formed by the fibers 118(1) and 118(2) may be by pleating fabric (similar to filter paper or accordion), making handling of the many layers of fibers in pre-consolidated fabric structure 118 much easier. The compressive-force handling substructure (e.g., the pre-consolidated fabric structure 118) may be pre-consolidated by dedicated tooling to minimize air pockets (i.e., maximize compressive modulus) prior to assembling/bonding/melting on the parallel first stack of fiber panels 102, second stack of fiber panels 108, etc., to the pre-consolidated fabric structure 118.

In one aspect, one or more processes in the method 300 are carried out by a robotic arm/robotic methods or other types of dedicated tooling, controlled by a processor (not shown), for example. In one aspect, one or more processes in the method 300 may be carried out manually. In one aspect, one or more processes in the method 300 may be carried out using a combination of manual and robotic actions, as may be contemplated by one of ordinary skill in the art in view of this disclosure. Further, in one aspect, processes in the method 300 may be transferable between a human operator (not shown) and a robotic arm. Furthermore, one or more processes may be skipped or combined as a single process, repeated several times, and the flow of processes in the method 300 may be in any order not limited by the specific order illustrated in FIG. 3. For example, one or more processes may be moved around in terms of their respective orders, or may be carried out in parallel.

Referring now to FIG. 3, the method 300 may begin in an operation 302 by creating the fiber panel 202. The creating may be carried out manually or using a robotic arm or other dedicated tooling.

In an operation 304, the fiber panel 202 may be divided into the plurality of strips 204 along the dividing lines 206 in a first direction using a suitable cutting or dividing tool (e.g., a saw, water jet cutting tool, a laser cutting tool, etc.). The first direction in which such dividing or cutting is carried out may be parallel to or substantially parallel to an edge of the fiber panel 202. In one aspect, such dividing may be carried out along one of X, Y, or Z axes of FIG. 1. Alternatively, such dividing may be carried out in a direction non-parallel to any of the X, Y, and Z axes of FIG. 1. When non-parallel dividing of the fiber panel 202 is carried out, the dividing lines 206 may be at an angle with one of the edges (e.g., lengthwise edge) of the fiber panel 202. As discussed, the fiber panel 202 may be a stack of composite material.

In an operation 306, after the fiber panel 202 has been divided into the plurality of strips 204, rotating of the plurality of strips 204 is carried out. Thereafter, the plurality of strips 204 may be pushed together, for example, by pushing the plurality of strips 204 in a direction along the arrows 216, and consolidated or cured to form another composite panel (interchangeably referred to as a second panel). In one aspect, the plurality of strips 204 are rotated by 90°. As a result, the plurality of strips 204 comprise fibers plied perpendicular or substantially parallel to the YZ-plane in FIG. 1.

In an operation 308, a fiber panel, e.g., the fiber panel 210, is placed or laid on the consolidated, rotated plurality of strips 204, now referred to as the second panel. Similar to creating or assembling the fiber panel 202, the fiber panel 210 may be laid on top of the composite panel formed by the rotated plurality of strips 204. Attaching the fiber panel 210 may be carried out in a manner such that orientation of the consolidated, rotated plurality of strips 204 is not disturbed or changed. Concurrently, fiber panel 212 may be attached to the bottom of the consolidated, rotated plurality of strips 204.

In an operation 310, the resulting composite plate is divided into another plurality of strips (not shown) along the dividing lines 208 in a second direction using a suitable cutting or dividing tool (e.g., a saw, a water jet tool, a laser cutting tool, etc.). The second direction in which such dividing or cutting is carried out may be parallel to or substantially parallel to an edge of the fiber panel 210 different from the edge of the fiber panel 202. The dividing lines 208 may be along the X-axis of the composite material structure 100. For example, as illustrated in FIG. 2, such edge of the fiber panel 210 may be perpendicular to the edge of the fiber panel 202 along which the dividing lines 206 are aligned. In one aspect, such dividing may be carried out along one of X, Y, or Z axes of FIG. 1. Alternatively, such dividing may be carried out in a direction non-parallel to any of the X, Y, and Z axes of FIG. 1. When non-parallel dividing of the formed composite plate is carried out, the dividing lines 208 may be at an angle with one of the edges (e.g., breadthwise edge) of the fiber panel 210. The second rotated plurality of strips (not shown) may be consolidated to form the second composite panel. As discussed, the fiber panel 210 may be a stack of composite material.

In an operation 312, the third stack of fiber panels 120, the fourth stack of fiber panels 122, and the other fiber panels opposite the third stack of fiber panels 120, the fourth stack of fiber panels 122 are attached on the exposed sides of the three dimensional fiber structure or mesh of the pre-consolidated fabric structure 118 formed. For example, the third stack of fiber panels 120 is attached along the YZ-plane, and the fourth stack of fiber panels 122 are attached along the XZ-plane. Such attaching may comprise bonding, fusing, curing, or melting one or more of the first stack of fiber panels 102, the second stack of fiber panels 108, the third stack of fiber panels 120, the fourth stack of fiber panels 122, and the other fiber panels to the composite material structure 100. Such bonding, fusing, or melting being known to one of ordinary skill in the art, will thus not be described in detail herein. In one aspect, such attaching of the third stack of fiber panels 120, the fourth stack of fiber panels 122, and the opposing fiber panels (not shown) on the sides of the three dimensional fiber structure or mesh of the pre-consolidated fabric structure 118 may be carried out such that the fibers of the third stack of fiber panels 120, the fourth stack of fiber panels 122, and the opposing fiber panels are at an angle with respect to the X, Y, and Z axes shown in FIG. 1. In one embodiment, the stack of fiber panels 122 is constructed so that the fibers are non-orthogonal, at angle θ, to the top and bottom skin fiber panels 102 and 108. These fibers, e.g., +/−45° from the vertical perpendicular line 126 are arranged to increase the shear modulus beyond that exhibited by the combination of top skin 102, bottom skin 108, and pre-consolidated fabric structure 118 alone.

In an operation 314, the composite material structure 100 is incorporated into a construction machine. Thereafter, compression, tension, flexure, shear, and torsion forces are applied to a beam or other component based on the composite material structure 100. The forces may be applied, for example during a lifting cycle of an excavator stick, or the like, made of the composite material structure 100. The forces may be applied, for example, during a digging cycle of the excavator stick made of the composite material structure 100. Such an excavator stick may be, for example, a part of the EL300® series of machines provided by Caterpillar, Inc. of Peoria, Ill. used for construction and mining. During a representative flexural loading shown by arrow 124, the compression forces are absorbed along the X-axis by the pre-consolidated fabric structure 118 in region shown by arrows 115, which can handle the compression load resulting from the flexural forces. As a result, delamination or buckling of the second stack of fiber panels 108 does not occur, while the first stack of fiber panels 102 carries the resultant tensile loading, and the fourth stack of fiber panels 122 carries the resultant shear loading. Further, construction of the composite material structure 100 using the material arrangements 200, for example, may be accomplished without using complex weaving arrangements or fabric guiding parts thereof.

The many features and advantages of the various aspects are apparent from the detailed specification, and, thus, it is intended by the appended claims to cover all such features and advantages of the various aspects which fall within its true spirit and scope. Further, since numerous modifications and variations will readily occur to those skilled in the art, it is not desired to limit the various aspects to the exact construction and operation illustrated and described, and, accordingly, all suitable modifications and equivalents may be resorted to that fall within the scope of the various aspects discussed.

What is claimed is:

1. A composite material structure, comprising:
a first stack of fiber panels arranged with fibers parallel to a loading axis to accommodate a first tension load in a first plane;
a second stack of fiber panels arranged with fibers parallel to the loading axis to accommodate a second tension load in a second plane; and
a pre-consolidated fabric structure between the first and the second stack arranged with fibers plied perpendicular to the fibers of the first stack of fiber panels and perpendicular to the fibers of the second stack of fiber panels, the fibers further being orthogonal to the loading axis.

2. The composite material structure of claim 1, wherein the composite material in the pre-consolidated fabric structure is a high modulus fiber material comingled with a polymer matrix.

3. The composite material structure of claim 1, wherein the composite material in the composite material structure is substantially composed of self-reinforced polymer.

4. The composite material structure of claim 1, wherein the first plane and the second plane are separated by at least 1″.

5. The composite material structure of claim 1 further comprising:
a third and/or a fourth stack of fiber panels perpendicular to the first and the second stack arranged to cover the pre-consolidated fabric structure on sides thereof.

6. The composite material structure of claim 5, wherein the fourth stack of fiber panels comprises fibers that are at an angle of 25°-65° with respect to either one of the first or the second planes.

7. An excavator stick made using the composite material structure of claim 1.

8. The composite material structure of claim 1, wherein the pre-consolidated fabric structure is a substantially two-dimensional mesh.

9. A method of manufacturing a composite material structure for alternating flexural loading comprising compressive and tensile stresses, the method comprising:
dividing a first panel of a composite material into a plurality of strips along a first direction;
combining the plurality of strips to form a second panel;
attaching a plurality of fiber panels on the top and bottom of the second panel to form a composite plate; and
dividing the composite plate of the composite material into a plurality of strips along a second direction, the plurality of strips along the first and the second directions forming a composite material structure.

10. The method of claim 9 further comprising:
attaching a plurality of fiber panels on sides of the composite material structure.

11. The method of claim 9, wherein the composite material is a high modulus fiber material co-mingled with a polymer matrix.

12. The method of claim 9, wherein the composite material is a self-reinforced polymer.

13. The method of claim 9, wherein the first panel comprises 8-200 layers of fabric of the composite material and is between 0.25″ and 2.0″ thick.

14. The method of claim 13 further comprising:
arranging the plurality of strips of the divided first stack by rotating by 90° around an axis delineated by the first direction.

15. The method of claim 14 further comprising:
consolidating the rotated plurality of strips to form a second composite panel.

16. The method of claim 15 further comprising:
attaching top and bottom skins to the second composite panel to form a composite plate.

17. The method of claim 16 further comprising:
dividing the composite plate into beams orthogonally to a fabric plane of the composite material in the rotated plurality of strips.

18. The method of claim 17 further comprising:
attaching edge panels comprised of fabric with fiber orientation at an angle of 25°-65° with respect to the top and bottom skins.

19. The method of claim 9, wherein the attaching comprises bonding or fusing the plurality of fiber panels on the top and bottom of the second composite panel.

20. The method of claim 9 further comprising:
applying alternating flexural loading to the formed composite material structure.

21. An excavator stick, comprising:
a pre-consolidated fabric structure made of a composite material between a first and a second stack of fiber panels arranged with fibers plied perpendicular to fibers of the first stack of fiber panels and perpendicular to the fibers of the second stack of fiber panels, the fibers further being orthogonal to a loading axis along which the excavator stick receives flexural forces.
